(19) United States
(12) Patent Application Publication
(10) Pub. No.: US 2025/0190517 A1
(43) Pub. Date: Jun. 12, 2025

(54) MULTI-MODE MULTI-CHANNEL STREAMING FAST FOURIER TRANSFORM (FFT) ARCHITECUTRE

(71) Applicant: Synopsys, Inc., Sunnyvale, CA (US)

(72) Inventors: Venugopal SANTHANAM, Bengaluru (IN); Sangeeth Kumar BURUSU, Andhra Pradesh (IN)

(21) Appl. No.: 18/533,413

(22) Filed: Dec. 8, 2023

(51) Int. Cl. G06F 17/14; G06F 7/523

(52) U.S. Cl. CPC G06F 17/142; G06F 7/523

(57) ABSTRACT

Certain aspects of the present disclosure are directed towards a configurable Fourier transform circuit. The circuit includes a first input Fourier transform component having a first set of multiplexers, wherein the first input Fourier transform component is configurable to perform Fourier transforms of different sizes and different number of channels by controlling the first set of multiplexers; a first set of multiplier circuits having inputs coupled to outputs of the first input Fourier transform component; and a first output Fourier transform component having inputs coupled to outputs of the first set of multiplier circuits and having a second set of multiplexers, wherein the first output Fourier transform component is configurable to perform Fourier transforms of different sizes and different number of channels by controlling the second set of multiplexers.

### TECHNICAL FIELD

The present disclosure generally relates to an electronic circuit, and more particularly, to circuitry for performing a fast Fourier transform (FFT).

### BACKGROUND

A fast Fourier transform (FFT) is an algorithm for computing a discrete Fourier transform of a sequence. FFT is used to convert a signal from the time domain to a representation in the frequency domain. The FFT is vastly used across many applications such as radio frequency (RF) transceivers, signal processing, orthogonal frequency division multiplexing (OFDM), radio detection and ranging (radar), or magnetic resonance imaging (MRI).

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Certain aspects of the present disclosure are directed towards a configurable Fourier transform circuit. The circuit generally includes: a first input Fourier transform component having a first set of multiplexers, wherein the first input Fourier transform component is configurable to perform Fourier transforms of different sizes by controlling the first set of multiplexers; a first set of multiplier circuits having inputs coupled to outputs of the first input Fourier transform component; and a first output Fourier transform component having inputs coupled to outputs of the first set of multiplier circuits and having a second set of multiplexers, wherein the first output Fourier transform component is configurable to perform Fourier transforms of different sizes by controlling the second set of multiplexers.

Certain aspects of the present disclosure are directed towards a method for configuring a Fourier transform circuit. The method generally includes: performing, via a first input Fourier transform component, Fourier transforms of one of multiple sizes by controlling a first set of multiplexers of the first input Fourier transform component; performing, via a first output Fourier transform component, Fourier transforms of one of the multiple sizes by controlling a second set of multiplexers of the first output Fourier transform component; generating first input side Fourier transform signals via the configured first input Fourier transform component; performing twiddle factor multiplications for the first input side Fourier transform signals via a first set of multiplier circuits to yield first multiplier output signals; and generating first output side Fourier transform signals via the configured first output Fourier transform component based on the first multiplier output signals.

Certain aspects of the present disclosure are directed towards an apparatus for configuring Fourier transform circuit. The apparatus generally includes a memory and one or more processors coupled to the memory, the one or more processors being configured to: configure a first input Fourier transform component to perform Fourier transforms of one of multiple sizes by controlling a first set of multiplexers of the first input Fourier transform component; and configure a first output Fourier transform component to perform Fourier transforms of one of the multiple sizes by controlling a second set of multiplexers of the first output Fourier transform component. In some aspects, first input side Fourier transform signals are generated via the configured first input Fourier transform component, first multiplier output signals are generated by performing twiddle factor multiplications for the first input side Fourier transform signals, and first output side Fourier transform signals are generated via the configured first output Fourier transform component based on the first multiplier output signals.

Certain aspects of the present disclosure are directed towards a non-transitory computer-readable medium storing information representing a configurable Fourier transform circuit, comprising: a first input Fourier transform component having a first set of multiplexers, wherein the first input Fourier transform component is configurable to perform Fourier transforms of different transform sizes by controlling the first set of multiplexers; a first set of multiplier circuits having inputs coupled to outputs of the first input Fourier transform component; and a first output Fourier transform component having inputs coupled to outputs of the first set of multiplier circuits and having a second set of multiplexers, wherein the first output Fourier transform component is configurable to perform Fourier transforms of different transform sizes by controlling the second set of multiplexers.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an example architecture for performing a fast Fourier transform (FFT).

FIG. 2 is a timing diagram illustrating example operations for performing a streaming FFT, in accordance with certain aspects of the present disclosure.

FIG. 3 illustrates an architecture for performing a streaming FFT, in accordance with certain aspects of the present disclosure.

FIG. 4 illustrates pipelined FFT architectures for different transform sizes, in accordance with certain aspects of the present disclosure.

FIG. 5 illustrates an FFT architecture that is reconfigurable, in accordance with certain aspects of the present disclosure.

FIGS. 6A to 6E illustrates calculation stages for performing FFT operations, in accordance with certain aspects of the present disclosure.

FIG. 7 illustrates a configurable FFT architecture, in accordance with certain aspects of the present disclosure.

FIGS. 8A and 8B illustrate example multiplexers and adders used to implement different FFT configurations, in accordance with certain aspects of the present disclosure.

FIGS. 9, 10, 11, and 12 are timing diagrams that illustrate example operations for performing FFT operations, respectively, in accordance with certain aspects of the present disclosure.

FIG. 13 is a flow diagram illustrating example operations for configuring a Fourier transform circuit, in accordance with certain aspects of the present disclosure.

FIG. 14 illustrates an example machine of a computer system within which a set of instructions, for causing the machine to perform any one or more of the methodologies discussed herein, may be executed.

### DETAILED DESCRIPTION

Certain aspects of the present disclosure are directed towards an area efficient low latency streaming fast Fourier transform (FFT) architecture. The FFT is widely used across many applications, such as radio frequency (RF) transceivers, signal processing, orthogonal frequency division multiplexing (OFDM), radio detection and ranging (radar), or magnetic resonance imaging (MRI). Some aspects provide a multi-mode and multi-channel FFT computation. The architecture described herein allows for sharing FFT logic to calculate one 256-point FFT, two 128-point FFTs, four 64-point FFTs, or eight 32-point FFTs, making the architecture area efficient and scalable. While 256-point, 128-point, 64-point, and 32-point FFTs are described to facilitate understanding, the aspects of the present disclosure may be used to implement a configurable FFT architecture for any sizes of FFT. A 256-point FFT refers to an FFT performed on an input having 256 points (values), a 128-point FFT refers to an FFT performed on an input having 128 points (values), and so on. The number of channels and modes may be switched in run time without using multiple instances supporting multi-channel and multi-mode. Calculating one 256-point FFT, two 128-point FFTs, four 64-point FFTs, or eight 32-point FFTs using independent architecture involves implementing multiple instances of FFTs, leading to higher consumption of area. To reduce area consumption, the implementation of the present disclosure shares the data path for the speed modes of FFTs.

A pipelined architecture for performing FFT is performed based on the following equations. For example, the following equation may be used to perform a 256-point FFT:

$$X ( K ) = X ( 16 r + s ) = {\sum }_{m = 0}^{15} {W}_{16}^{m r} {W}_{256}^{m s} {\sum }_{l = 0}^{15} x ( 16 l + m ) {W}_{16}^{s l} r = 0 to 15 ,$$

$$s = 0 to 15$$

the following equation may be used to perform a 128-point FFT:

$$X ( K ) = X ( 8 r + s ) = {\sum }_{m = 0}^{15} {W}_{16}^{m r} {W}_{128}^{m s} {\sum }_{l = 0}^{7} x ( 16 l + m ) {W}_{16}^{s l} r = 0 to 15 , s = 0 to 7$$

the following equation may be used to perform a 64-point FFT:

$$X ( K ) = X ( 8 r + s ) = {\sum }_{m = 0}^{7} {W}_{8}^{m r} {W}_{32}^{m s} {\sum }_{l = 0}^{7} x ( 8 l + m ) {W}_{8}^{s l} r = 0 to 7 , s = 0 to 7$$

the following equation may be used to perform a 32-point FFT:

$$X ( K ) = X ( 4 r + s ) = {\sum }_{m = 0}^{7} {W}_{8}^{m r} {W}_{32}^{m s} {\sum }_{l = 0}^{3} x ( 8 l + m ) {W}_{4}^{s l} r = 0 to 7 , s = 0 to 3$$

where x is the input having, 256, 128, 64, or 32 points as described, and W is the twiddle factor equal to:

$${e}^{- j \frac{2 π n k}{N}}$$

For instance, W₂₅₆^{ms} may be equal to:

$${e}^{- j \frac{2 π m s}{256}}$$

The basis of the FFT is that a Discrete Fourier Transform (DFT) can be divided into two smaller DFT's. In the current architecture of FFT256 (e.g., 256-point FFT), a radix-16 FFT algorithm may be used where the DFT is divided into two 2 smaller DFTs of length 16, as shown in the equation for performing a 256-point FFT.

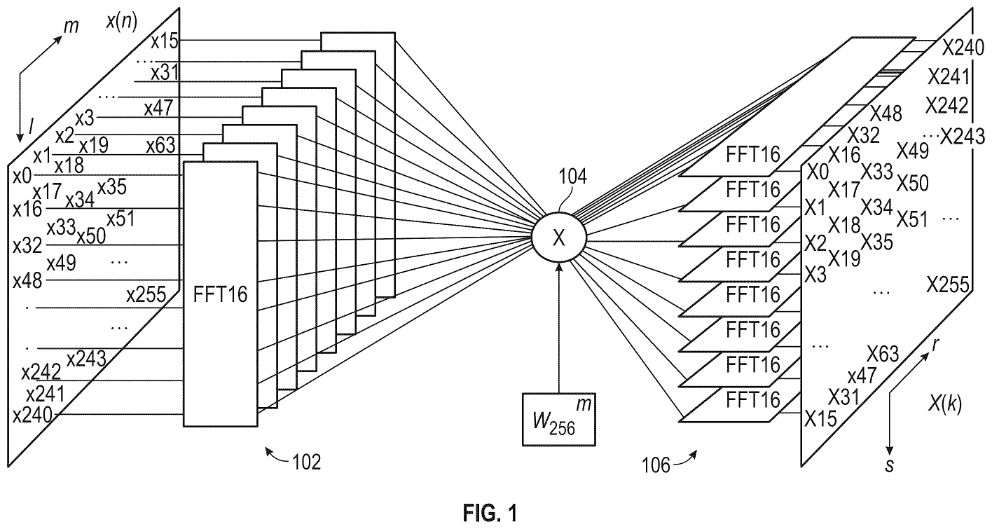

FIG. 1 illustrates an example architecture for performing a 256-point FFT. As shown, an input x(n) of 256 values (x0 to x255) may be received, organized in m columns (e.g., where m is from 0 to 15) and l rows (e.g., where l is from 0 to 15). As shown, a 16-point FFT operation (e.g., input FFT operations 102) may be performed for each of the 16 columns. The output of each 16-point FFT operations may be multiplied by the twiddle factor (W₂₅₆^{m}) using a multiplier 104. The output of the multiplier 104 may be reordered (e.g., transposed) and output FFT operations 106 may be performed based on the reordered outputs of the multiplier 104 to generate FFT output X(k).

In other words, the input x(n) is divided into a 2-dimensional array of data and the input is fed column-wise to FFT components to compute 16-point FFTs. The result is multiplied by twiddle factor terms. The resulting data array of data X(16r+s) is calculated by another set of 16-point FFT's row-wise. The 16-point FFT, which is the base operation of FFT derivation, may be performed using the Winograd small-point FFT algorithm. The main advantage of this algorithm is that it reduces the number of additions and multiplications compared to other available FFT algorithms.

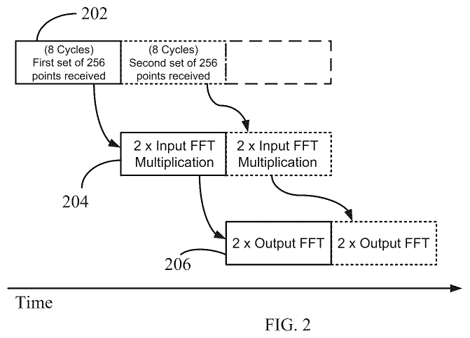

FIG. 2 is a timing diagram illustrating example operations for performing a streaming 256-point FFT, in accordance with certain aspects of the present disclosure. In some cases, an input interface may provide 32 symbols (input values) per clock. Thus, to perform a 256-point FFT (e.g., receive 256 input values at 32 values per clock cycle), the 256 input values may be provided across eight clock cycles. Thus, after the eight clock cycles 202, an input stream of 256 points may be received. After the eight clock cycles 202, input FFT processing may begin for the 256 points. To complete the 16-point FFT operations within 8 clock cycles, two 16-point FFT components working in parallel may be used. That is, a 16-point FFT may operate by taking 16 inputs per clock cycle. Therefore, for 256 inputs (e.g., for a 256-point FFT), sixteen cycles may be needed to perform the 16-point FFT for the 256 inputs. Thus, to complete the 16-point input FFT within eight clock cycles, two 16-point FFT components may be used. Once the inputs are received after the clock cycles 202, two 16-point FFT components may operate in parallel to perform input FFT operations (e.g., and multiplication by twiddle factors) during a subsequent eight clock cycles 204 (e.g., while a second set of 256 inputs are received in parallel), as shown. Once the input FFT and multiplication with twiddle factor is completed after cycles 204, during a subsequent eight clock cycles 206, the output FFT operations may be performed using another two FFT components operating in parallel.

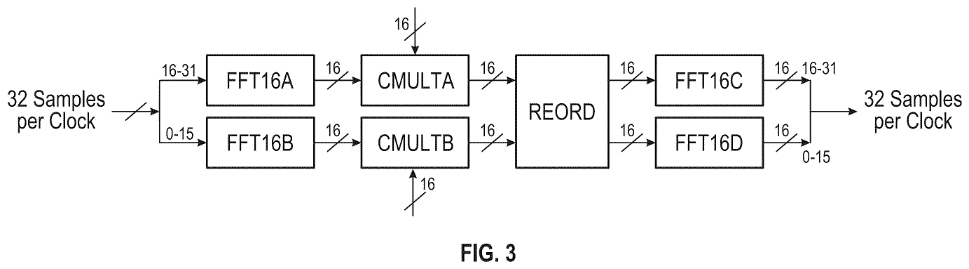

FIG. 3 illustrates an architecture for performing a streaming 256-point FFT, in accordance with certain aspects of the present disclosure. As shown, 32 samples (e.g., input values) may be received per clock cycle, where samples 0-15 are processed using an FFT component labeled “FFT16B” and samples 16-31 are processed using an FFT component labeled “FFT16A.” The outputs of the FFT components are multiplied by respective twiddle factors (labeled “TW”) using multiplier components labeled “CMULTA” and “CMULTB.” The outputs are then reordered and processed using output FFT components labeled “FFT16C” and “FFT16D”, as shown.

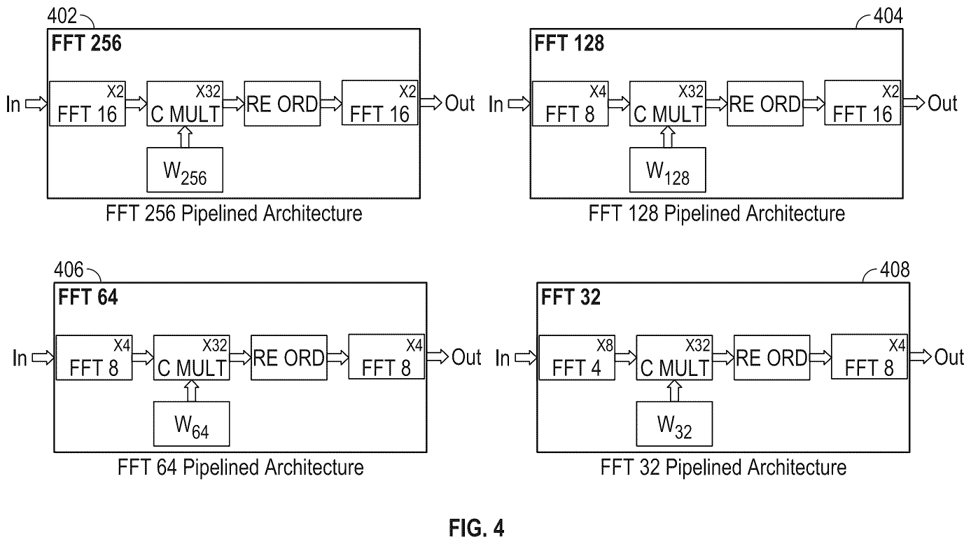

FIG. 4 illustrates pipelined FFT architectures for transform sizes 256, 128, 64, and 32, in accordance with certain aspects of the present disclosure. The 256-point FFT architecture 402 may include two input 16-point FFT components, 32 multiplier components (e.g., for multiplication by twiddle factors), reordering routes, and two output 16-point FFT components.

The transform size of 128 (e.g., for the 128-point FFT architecture 404) may include four input 8-point FFT components and two output 16-point FFT components. For the 128-point FFT, 16 symbols may be fed per clock from each of two channels (e.g., two 128-point FFT streams). For 128-point FFT, sixteen 8-point FFT components may be used. But to perform the FFT operation in 8 clock cycles, each channel may have two 8-point FFT components (e.g., four 8-point FFT components in total). The output FFT operation for the 128-point FFT may use two 16-point FFT components, as shown.

For the transform size of 64 (e.g., for the 64-point FFT architecture 406), four 8-point FFT components may be used at the input and output sides. The 64-point FFT may be implemented with eight 8-point FFT components (e.g., four 8-point FFT components at the input and four 8-point FFT components at the output) for each channel, as four channels of 64-point FFT may be supported.

For the transform size of 32 (e.g., for the 32-point FFT architecture 408), eight 4-point FFT components may be implemented at the input and four 8-point FFT components may be implemented at the output. The 32-point FFT may be fed with four symbols per clock from each channel, supporting eight channels of 32-point FFT.

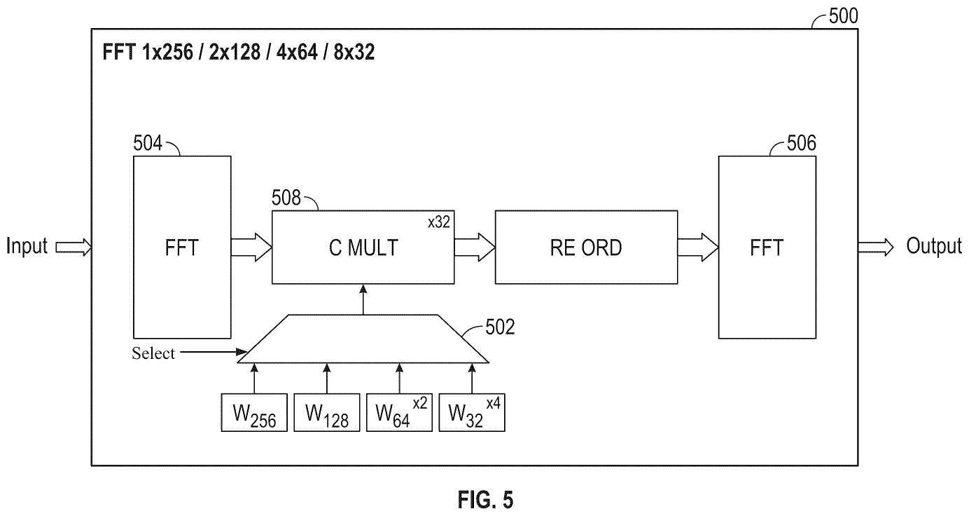

FIG. 5 illustrates an FFT architecture 500 that is reconfigurable as one 256-point FFT, two 128-point FFTs, four 64-point FFTs, or eight 32-point FFTs, in accordance with certain aspects of the present disclosure. As shown, the architecture 500 may include input FFT components 504 and output FFT components 506. The output signals of the input FFT components may be provided to multiplier components 508. The FFT components 504 may correspond to FFT16A and FFT16B shown in FIG. 3 and the FFT components 506 may correspond to FFT16C and FFT16D shown in FIG. 3. To reconfigure the architecture 500, each of the FFT components 504 and FFT components 506 may be configured as two 16-point FFT components, four 8-point FFT components, or eight 4-point FFT components. For example, each of the FFT16A, FFT16B, FFT16C, and FFT16D may be implemented as either one 16-point FFT, two 8-point FFTs, or four 4-point FFTs.

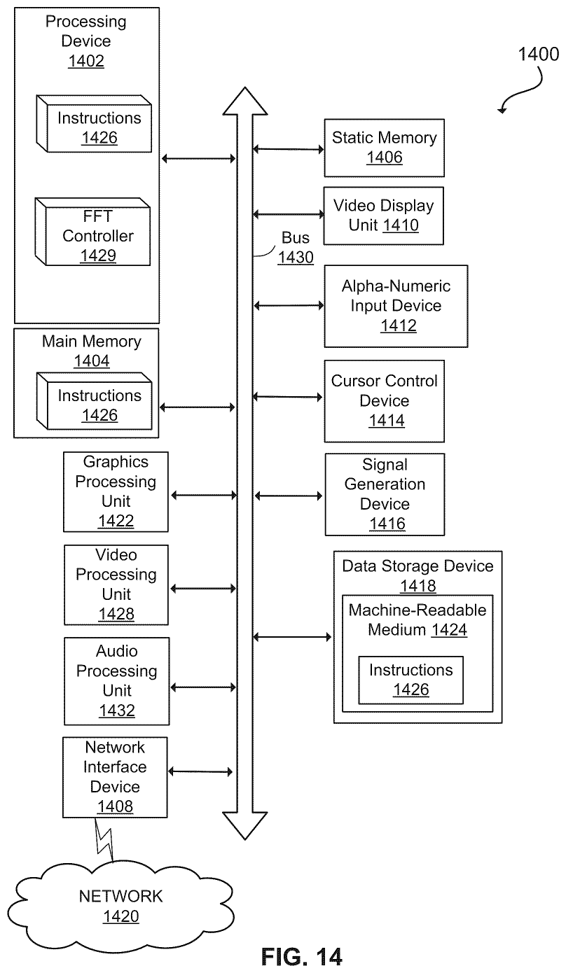

Moreover, the architecture 500 may include a multiplexer 502 which allows for selection of twiddle factors based on whether the architecture 500 is configured as one 256-point FFT, two 128-point FFTs, four 64-point FFTs, or eight 32-point FFTs. It is appreciated that the architecture 500 may include one or a combination from the 256-point FFT, two 128-point FFTs, four 64-point FFTs, and eight 32-point FFTs, without deviating from the scope of the present disclosure. The twiddle factor multiplier (e.g., multiplier components 508 of FIG. 5) may perform the complex multiplication of twiddle values and the array of FFT16 output values. To support the shared logic, twiddle values are selected via the multiplexer 502 with a select line being configured based on the mode of operation (e.g., whether the architecture is configured to perform one 256-point FFT, two 128-point FFTs, four 64-point FFTs, or eight 32-point FFTs). The select line for the multiplexers described herein (e.g., multiplexer 502) may be controlled via a processing device, such as the processing device 1402 of FIG. 14. Based on the mode, the associated twiddle value will be provided and a complex multiplication is performed. The output of the twiddle factor multiplier is given to the reorder routes where the outputs from the twiddle factor multiplier across the cycles are reordered and fed to the output FFT components.

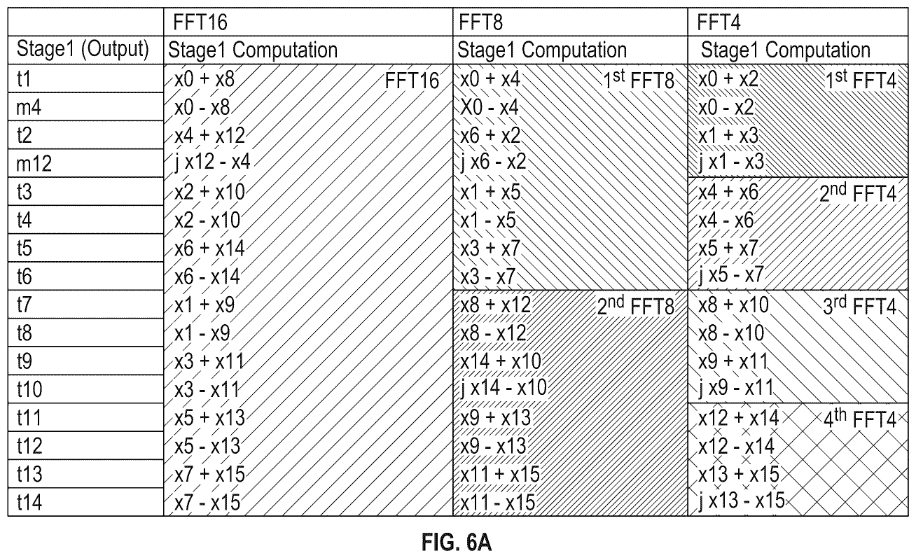

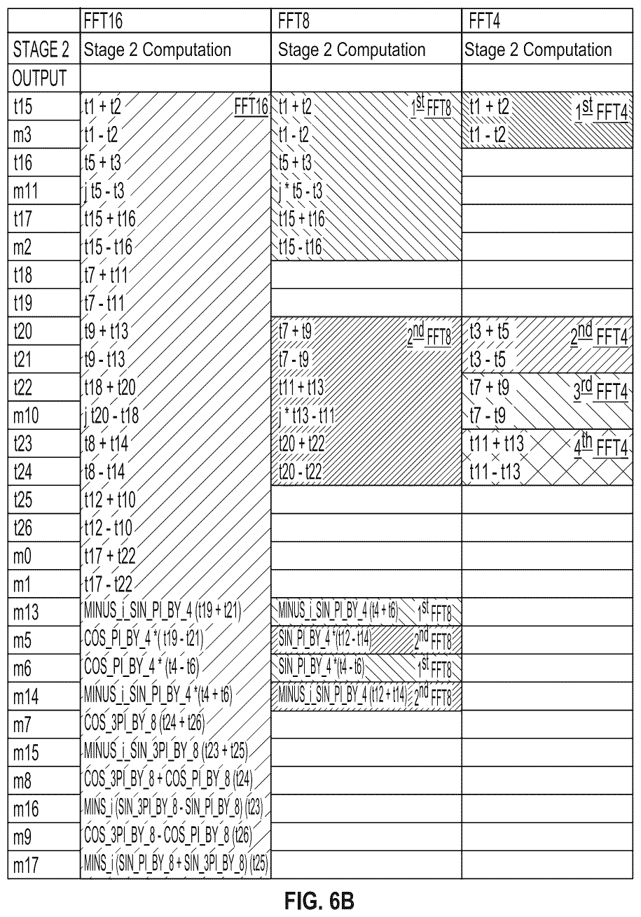

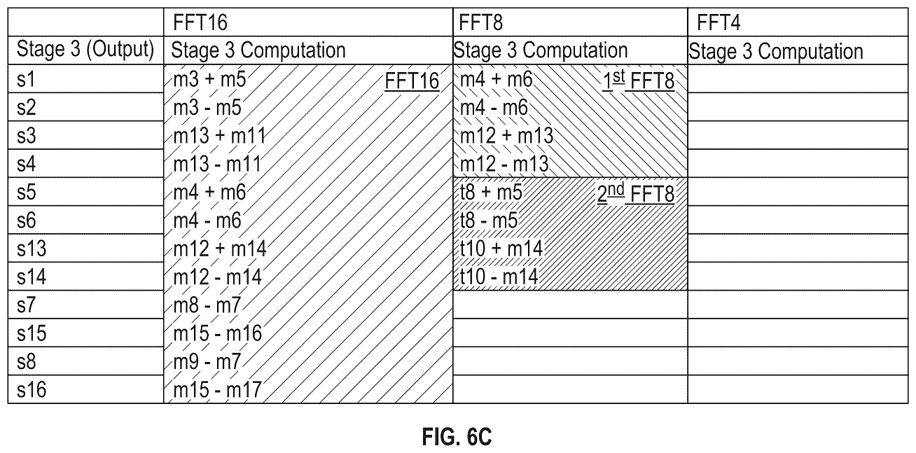

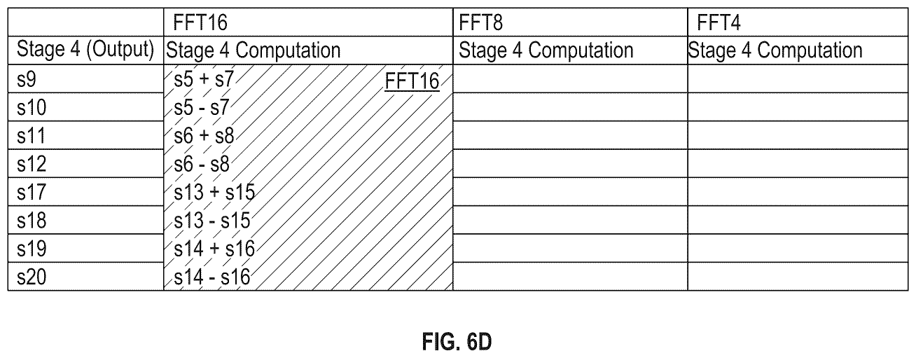

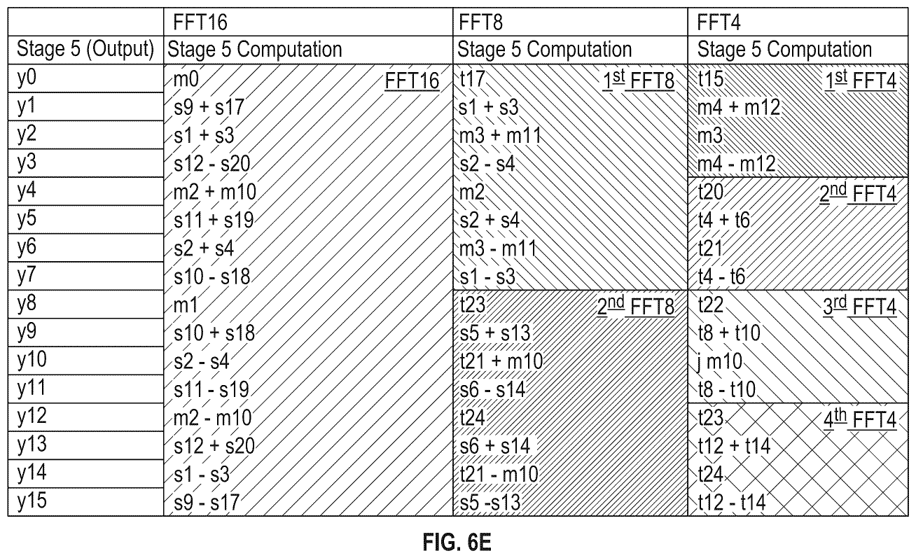

FIGS. 6A to 6E illustrate calculation stages for performing FFT operations. Each of the FFT16A, FFT16B, FFT16C, and FFT16D may be implemented by performing computations in several stages. For example, stage 1 may generate outputs t1 to t14, as well as outputs m4 and m12. Output t1 may be generated based on the sum of inputs x0 and x8, the output m4 may be generated based on subtraction of x0 and x8, and so on. Similarly, the outputs from stage 1 may be used to perform computations in stage 2 and so on for the other stages. Similarly, each stage may include computations for a first 8-point FFT (labeled “1^{st} FFT8”) and a second 8-point FFT (labeled “2^{nd} FFT8”). Each stage may also include computations for a first 4-point FFT (labeled “1^{st} FFT4”), a second 4-point FFT (labeled “2^{nd} FFT4”), a third 4-point FFT (labeled “3^{rd} FFT4”), and a fourth 4-point FFT (labeled “4^{th} FFT4”), as shown. In some aspects, adders and subtractors may be shared for computations associated with the 16-point FFT, 8-point FFTs, and 4-point FFTs. For example, the same adder logic may be used to perform x0+x8 calculation for FFT16, to perform x0+x4 for the 1^{st} FFT8, and to perform x0+x2 calculation for the 1^{st} FFT4. Similarly, the same subtracter logic (e.g., or adder logic with an inversed input) may be used to perform x0-x8 calculation for FFT16, to perform x0-x4 for the 1^{st} FFT8, and to perform x0-x2 calculation for the 1^{st} FFT4. As another example, in the second stage, the same adder may be used to perform t9+t13 for FFT16, to perform t7+t9 for the 2^{nd} FFT8, and to perform t3+t5 may the 2^{nd} FFT4.

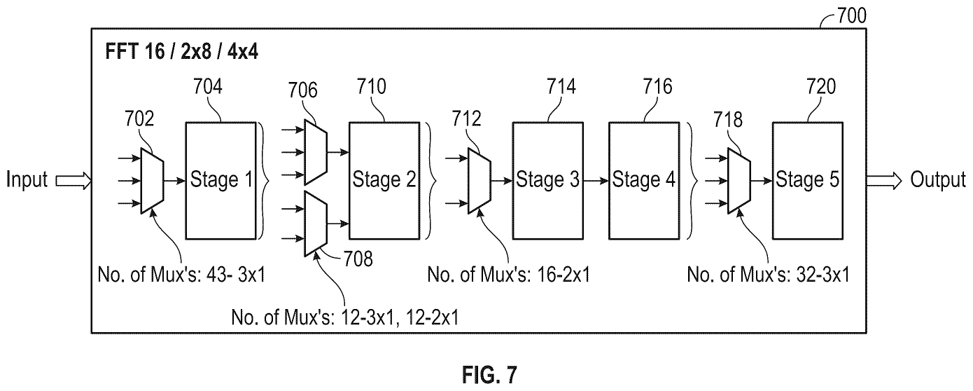

FIG. 7 illustrates a configurable FFT architecture 700, in accordance with certain aspects of the present disclosure. For example, each of the FFT16A, FFT16B, FFT16C, and FFT16D may be implemented using the architecture 700, allowing each FFT component to be configured as one 16-point FFT, two 8-point FFTs, or four 4-point FFTs. As shown, architecture 700 may include multiplexer circuitry 702 (e.g., to control the stage 1 computations as described with respect to FIG. 6A), which may include 43 3×1 multiplexers (e.g., 43 multiplexers having three inputs and one output). The output of the multiplexers may be provided to computation circuitry 704 for stage 1 computations. The architecture 700 may also include multiplexer circuitry 706 (e.g., 12 3×1 multiplexers used to control the stage 2 computations as described with respect to FIG. 6B) and multiplexer circuitry 708 (e.g., 12 2×1 multiplexers used to control the stage 2 computations as described with respect to FIG. 6B) having inputs coupled to outputs of computation circuitry 704. The outputs of the multiplexer circuitry 706, 708 may be provided to inputs of computation circuitry 710 for performing the stage 2 calculations.

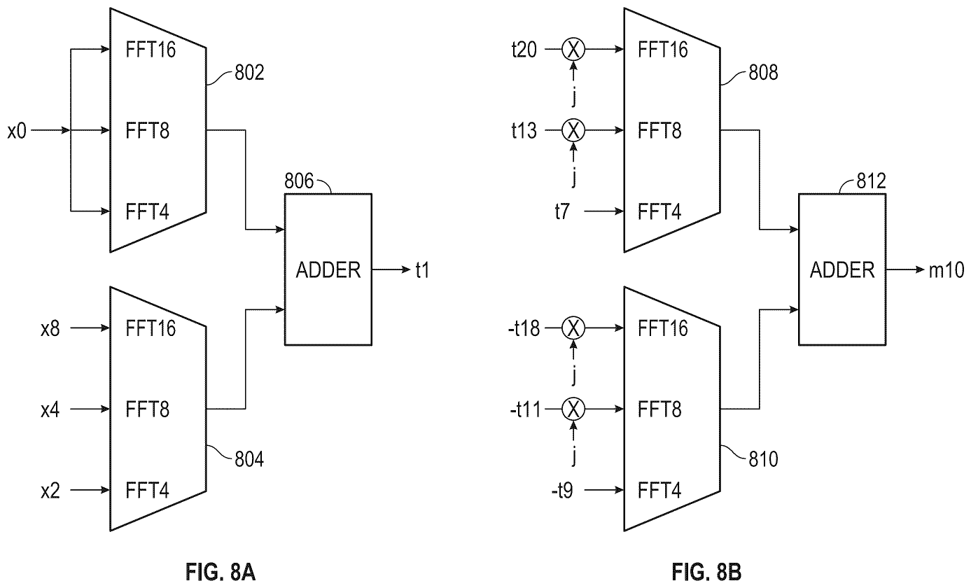

The architecture 700 may also include multiplexer circuitry 712 (e.g., including 16 3×1 multiplexers used to control the stage 3 computations as described with respect to FIG. 6C) having inputs coupled to outputs of the computation circuitry 710. The outputs of the multiplexer circuitry 712 may be coupled to inputs of computation circuitry 714 for performing the stage 3 calculations. The outputs from the stage 3 computations may be provided to inputs of computation circuitry 716 for stage 4 computations. The architecture 700 may also include multiplexer circuitry 718 (e.g., including 32 3×1 multiplexers used to control the stage 5 computations as described with respect to FIG. 6E) having inputs coupled to outputs of the computation circuitry 720 for stage 5 computations. Example techniques for controlling the multiplexing circuits described herein is provided in FIGS. 8A and 8B.

The hardware implementing the computation circuitry for each stage may be shared when implementing one 16-point FFT, two 8-point FFTs, or four 4-point FF. To do so, the inputs of computation circuitry are selected using multiplexers as described. Each stage generates intermediate outputs, which are generated based on multiplexing corresponding inputs to adders/subtractors, allowing the adder/subtractor circuitry to be shared.

FIG. 8A illustrates example multiplexers 802, 804 and adder 806 used to implement FFT16, FFT8, or FFT4 operations, in accordance with certain aspects of the present disclosure. As shown, the adder 806 may generate the output t1 for the stage 1 computation shows in FIG. 6A. For instance, for FFT16, the multiplexers 802, 804 may be controlled to output values x0 and x8 to the adder 806. For FFT8, the multiplexers 802, 804 may be controlled to output values x0 and x4 to the adder 806. For FFT4, the multiplexers 802, 804 may be controlled to output values x0 and x2 to the adder 806.

FIG. 8B illustrates example multiplexers 808, 810 and adder 812 used to implement FFT16, FFT8, or FFT4 operations, in accordance with certain aspects of the present disclosure. As shown, the adder 812 may generate the output m10 for the stage 2 computation shows in FIG. 6B. For instance, for FFT16, the multiplexers 808, 810 may be controlled to output values jt20 and −jt18 to the adder 812. For FFT8, the multiplexers 808, 810 may be controlled to output values jt13 and −jt11 to the adder 812. For FFT4, the multiplexers 808, 810 may be controlled to output values t7 and −t9 to the adder 812. In a similar manner, multiplexers may be implemented to share computation circuitry as the FFT architecture is reconfigured.

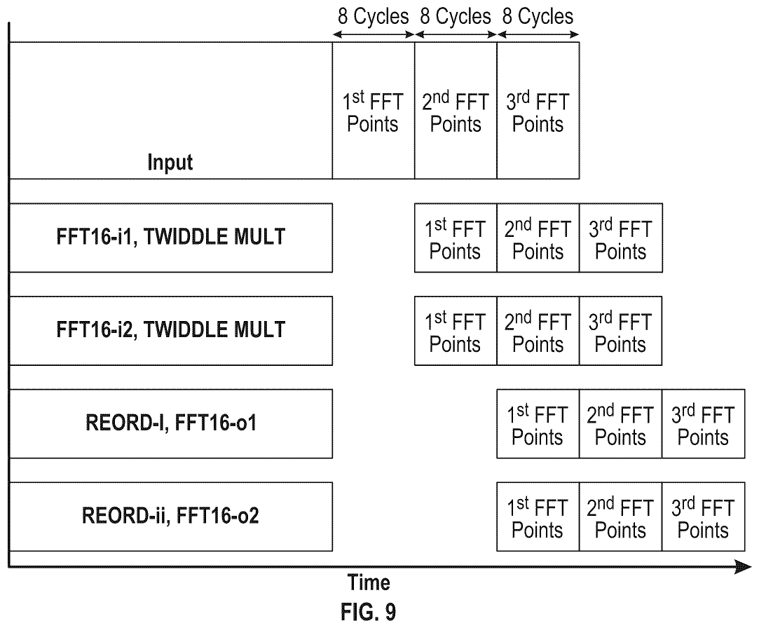

FIGS. 9, 10, 11, and 12 illustrate example operations for performing 256-point, 124-point, 64-point FFT, and 32-point FFT operations, respectively, in accordance with certain aspects of the present disclosure. As shown in FIG. 9, first FFT points (labeled “1^{st} FFT points”) may be received in eight clock cycles, second FFT points (labeled “2^{nd} FFT points”) may be received in eight clock cycles, and third FFT points (labeled “3^{rd} FFT points”) may be received in eight clock cycles. For example, the first FFT points may include 256 points for FFT. First and second input FFT components (e.g., corresponding to FFT16A and FFT16B in FIG. 3, and referred to as “FFT16-i1” and “FFT16-12” in FIG. 9) may be used to perform the input FFT operations on respective portions of the first FFT points, the second FFT points, and the third FFT points, along with the associated twiddle factor multiplication. First and second output FFT components (e.g., corresponding to FFT16C and FFT16D in FIG. 3 and referred to as “FFT16-o1” and “FFT16-o2” in FIG. 9) may be used to perform the output FFT operations, as shown.

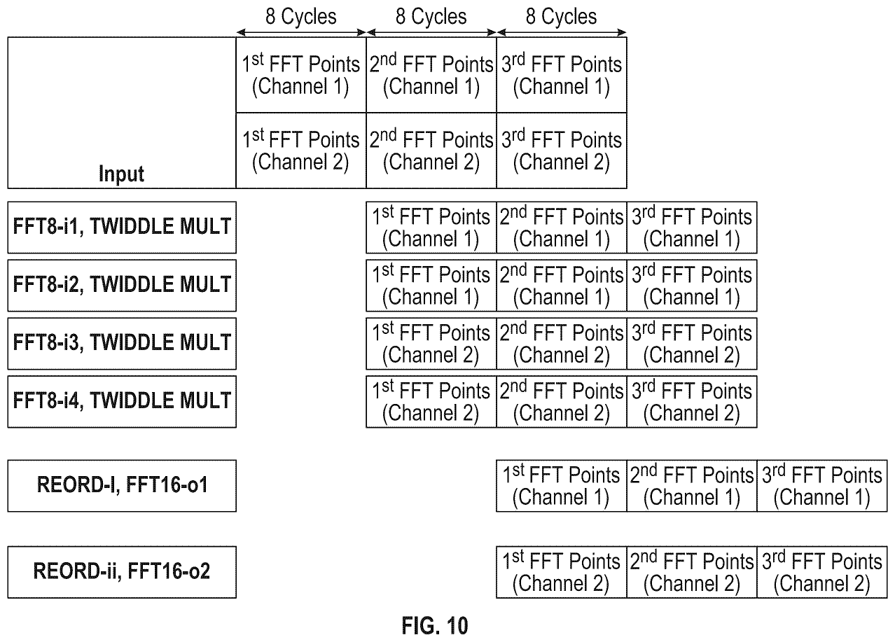

For the 128-point FFT operations shown in FIG. 10, FFT points may be received for two channels labeled “Channel 1” and “Channel 2”. FFT8-i1 and FFT8-i2 (e.g., corresponding to FFT16A of FIG. 3 configured as two FFT8s) may be used to process the FFT points for the first channel and FFT8-13 and FFT8-14 (e.g., corresponding to FFT16B of FIG. 3 configured as two FFT8s) may be used to process the FFT points for the second channel. Similarly, FFT1601 and FFT1602 may be used to perform the output FFT operations, as shown.

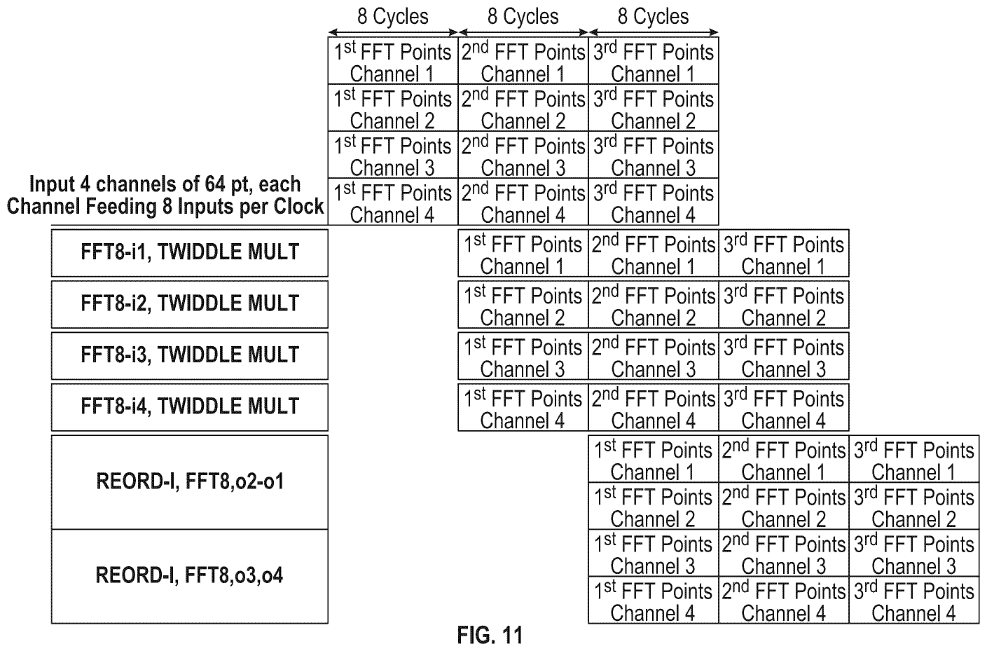

For the 64-point FFT as shown in FIG. 11, four channels of FFT points may be received. FFT8-i1, FFT8-12, FFT8-i3, and FFT8-14 may be used to perform the input FFT operations for the four channels, respectively, as shown. Similarly, FFT8-o1, FFT8-o2, FFT8-03, and FFT8-o4 may be used to perform the output FFT operations for the four channels, respectively, as shown. FFT8-o1 and FFT8-o2 may correspond to FFT16C of FIG. 3 configured as two FFT8s, and FFT8-o3 and FFT8-o4 may correspond to FFT16D of FIG. 3 configured as two FFT8s.

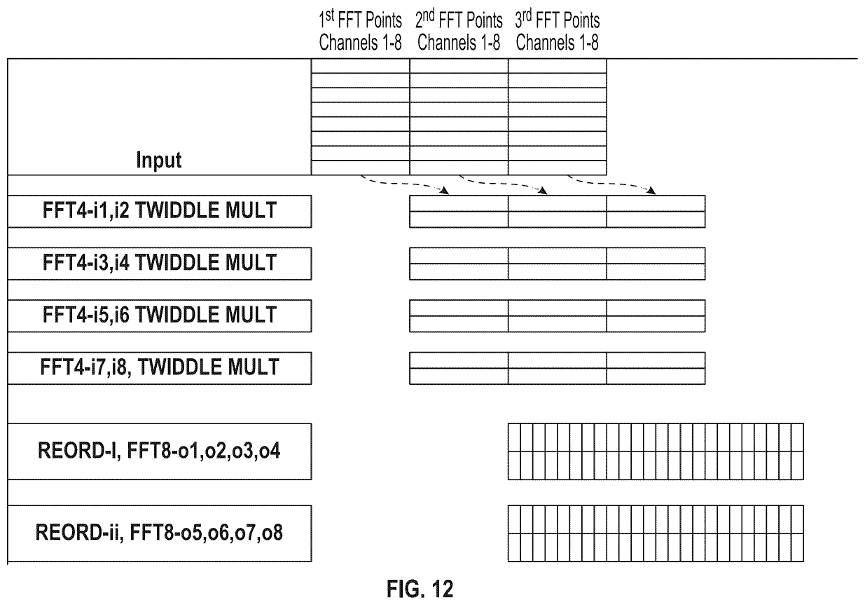

For the 32-point FFT shown in FIG. 12, eight channels FFT points may be received. Each of FFT16A and FFT16B shown in FIG. 3 may be configured as four FFT4s to implement FFT4-i1 to FFTi8 to perform the input FFT for the eight channels of the FFT points as shown. Similarly, each of FFT16C and FFT16D shown in FIG. 3 may be configured as four FFT4s to implement FFT4-o1 to FFT08 to perform the output FFT for the eight channels of the FFT points as shown.

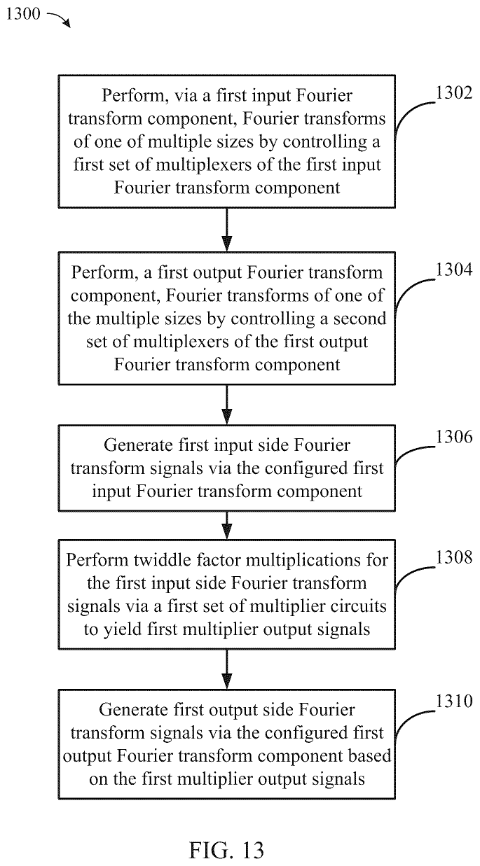

FIG. 13 is a flow diagram illustrating example operations 300 for configuring a Fourier transform circuit, in accordance with certain aspects of the present disclosure. In some aspects, the Fourier transform circuit may be configured to perform one 256-point Fourier transform, two 128-point Fourier transforms, four 64-point Fourier transforms, or eight 32-point Fourier transforms. The operations 300 may be performed by a Fourier transform circuit, such as the FFT circuit having the architecture 700.

At 1302, the Fourier transform circuit performs, via a first input Fourier transform component (e.g., FFT16A of FIG. 3), Fourier transforms of one of multiple sizes by controlling a first set of multiplexers (e.g., associated with the multiplexer circuitry 702, 706, 708, 712, or 718) of the first input Fourier transform component.

At 1304, the Fourier transform circuit performs, via a first output Fourier transform component (e.g., FFT16C of FIG. 3), Fourier transforms of one of the multiple sizes by controlling a second set of multiplexers of the first output Fourier transform component. In some aspects, at least one of the first input Fourier transform component or the first output Fourier transform component includes computation circuitry that is shared when performing the Fourier transforms of the multiple sizes. In some aspects, at least one of the first input Fourier transform component or the first output Fourier transform may be configured to perform one 16-point Fourier transform, two 8-point Fourier transforms, or four 4-point Fourier transforms.

At 1306, the Fourier transform circuit generates first input side Fourier transform signals via the configured first input Fourier transform component. At 1308, the Fourier transform circuit performs twiddle factor multiplications for the first input side Fourier transform signals via a first set of multiplier circuits to yield first multiplier output signals. At 1310, the Fourier transform circuit generates first output side Fourier transform signals via the configured first output Fourier transform component based on the first multiplier output signals.

In some aspects, the Fourier transform circuit may perform, via a second input Fourier transform component (e.g., FFT16B of FIG. 3), Fourier transforms of one of multiple sizes by controlling a third set of multiplexers of the second input Fourier transform component, and perform, via a second output Fourier transform component (e.g., FFT16D of FIG. 3), Fourier transforms of one of the multiple sizes by controlling a fourth set of multiplexers of the second output Fourier transform component. The Fourier transform may generate second input side Fourier transform signals via the configured second input Fourier transform component, perform twiddle factor multiplications for the second input side Fourier transform signals via a second set of multiplier circuits to yield second multiplier output signals, and generate output side Fourier transform signals via the configured second output Fourier transform component based on the second multiplier output signals.

In some aspects, generating the input Fourier transform signals includes performing computations via a computation circuit (e.g., corresponding to computation circuitry 704) coupled to outputs of the first set of multiplexers. In some aspects, generating the first output Fourier transform output signals may include performing computations via a computation circuit (e.g., corresponding to computation circuitry 704) coupled to outputs of the second set of multiplexers.

In some aspects, configuring the configurable Fourier transform circuit as a 256-point Fourier transform may include: performing, via the first input Fourier transform component, a 16-point Fourier transform; and performing, via the first output Fourier transform component, a 16-point Fourier transform. In some aspects, configuring the configurable Fourier transform circuit as two 128-point Fourier transforms may include: performing, via the first input Fourier transform component, two 8-point Fourier transforms; and performing, via the first output Fourier transform component, a 16-point Fourier transform. In some aspects, configuring the configurable Fourier transform circuit as four 64-point Fourier transforms may include: performing, via the first input Fourier transform component, two 8-point Fourier transforms; and performing, via the first output Fourier transform component, two 8-point Fourier transforms. In some aspects, configuring the configurable Fourier transform circuit as eight 32-point Fourier transforms may include: performing, via the first input Fourier transform component, four 4-point Fourier transforms; and performing, the first output Fourier transform component, two 8-point Fourier transforms.

In some aspects, the Fourier transform circuit may select, via a multiplexer (e.g., multiplexer 502), one of a plurality of twiddle factors based on a mode of operation of the Fourier transform circuit. The twiddle factor multiplications may be performed based on the selection.

FIG. 14 illustrates an example machine of a computer system 1400 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1400 includes a processing device 1402, a main memory 1404 (e.g., read-only memory (ROM), flash memory, dynamic random access memory (DRAM) such as synchronous DRAM (SDRAM), a static memory 1406 (e.g., flash memory, static random access memory (SRAM), etc.), and a data storage device 1418, which communicate with each other via a bus 1430.

Processing device 1402 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1402 may also be one or more special-purpose processing devices such as an application specific integrated circuit (ASIC), a field programmable gate array (FPGA), a digital signal processor (DSP), network processor, or the like. The processing device 1402 may be configured to execute instructions 1426 for performing the operations and steps described herein.

The computer system 1400 may further include a network interface device 1408 to communicate over the network 1420. The computer system 1400 also may include a video display unit 1410 (e.g., a liquid crystal display (LCD) or a cathode ray tube (CRT)), an alphanumeric input device 1412 (e.g., a keyboard), a cursor control device 1414 (e.g., a mouse), a graphics processing unit 1422, a signal generation device 1416 (e.g., a speaker), graphics processing unit 1422, video processing unit 1428, and audio processing unit 1432.

The data storage device 1418 may include a machine-readable storage medium 1424 (also known as a non-transitory computer-readable medium) on which is stored one or more sets of instructions 1426 or software embodying any one or more of the methodologies or functions described herein. The instructions 1426 may also reside, completely or at least partially, within the main memory 1404 and/or within the processing device 1402 during execution thereof by the computer system 1400, the main memory 1404 and the processing device 1402 also constituting machine-readable storage media.

In some implementations, the instructions 1426 include instructions to implement functionality corresponding to the present disclosure. While the machine-readable storage medium 1424 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1402 to perform any one or more of the methodologies of the present disclosure. The term “machine-readable storage medium” shall accordingly be taken to include, but not be limited to, solid-state memories, optical media, and magnetic media.

In some aspects of the present disclosure, the processing device 1402 may include an FFT controller 1429. The FFT controller 1429 may control one or more multiplexers to configure FFT circuitry, in accordance with certain aspects of the present disclosure.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A configurable Fourier transform circuit, comprising:
a first input Fourier transform component having a first set of multiplexers, wherein the first input Fourier transform component is configurable to perform Fourier transforms of different transform sizes by controlling the first set of multiplexers;
a first set of multiplier circuits having inputs coupled to outputs of the first input Fourier transform component; and
a first output Fourier transform component having inputs coupled to outputs of the first set of multiplier circuits and having a second set of multiplexers, wherein the first output Fourier transform component is configurable to perform Fourier transforms of different transform sizes by controlling the second set of multiplexers.

2. The configurable Fourier transform circuit of claim 1, wherein at least one of the first input Fourier transform component or the first output Fourier transform component comprises computation circuitry that is shared when performing the Fourier transforms of different sizes.

3. The configurable Fourier transform circuit of claim 1, further comprising:
a second input Fourier transform component having a third set of multiplexers, wherein the second input Fourier transform component is configurable to perform Fourier transforms of different sizes by controlling the third set of multiplexers, the first input Fourier transform component and the second input Fourier transform component being configured to receive different subsets of input signals for the configurable Fourier transform circuit;
a second set of multiplier circuits having inputs coupled to outputs of the second input Fourier transform component; and
a second output Fourier transform components having inputs coupled to outputs of the second set of multiplier circuits and having a fourth set of multiplexers, wherein the second output Fourier transform component is configurable to perform Fourier transforms of different sizes by controlling the fourth set of multiplexers, the first output Fourier transform component and the second output Fourier transform component being configured to generate different subsets of output signals for the configurable Fourier transform circuit.

4. The configurable Fourier transform circuit of claim 1, wherein the configurable Fourier transform circuit is configurable to perform one 256-point Fourier transform, two 128-point Fourier transforms, four 64-point Fourier transforms, or eight 32-point Fourier transforms.

5. The configurable Fourier transform circuit of claim 1, wherein at least one of the first input Fourier transform component or the first output Fourier transform component is configurable to perform one 16-point Fourier transform, two 8-point Fourier transforms, or four 4-point Fourier transforms.

6. The configurable Fourier transform circuit of claim 1, wherein the first input Fourier transform component comprises a computation circuit coupled to outputs of the first set of multiplexers, wherein inputs of the first set of multiplexers are coupled to inputs of the configurable Fourier transform circuit.

7. The configurable Fourier transform circuit of claim 1, wherein the first output Fourier transform component comprises a computation circuit coupled to outputs of the second set of multiplexers, wherein outputs of the computation circuit is coupled to outputs of the configurable Fourier transform circuit.

8. The configurable Fourier transform circuit of claim 1, wherein, to configure the configurable Fourier transform circuit as a 256-point Fourier transform:
the first input Fourier transform component is configured to perform a 16-point Fourier transform; and
the first output Fourier transform component is configured to perform a 16-point Fourier transform.

9. The configurable Fourier transform circuit of claim 1, wherein, to configure the configurable Fourier transform circuit as two 128-point Fourier transforms:
the first input Fourier transform component is configured to perform two 8-point Fourier transforms; and
the first output Fourier transform component is configured to perform a 16-point Fourier transform.

10. The configurable Fourier transform circuit of claim 1, wherein, to configure the configurable Fourier transform circuit as four 64-point Fourier transforms:
the first input Fourier transform component is configured to perform two 8-point Fourier transforms; and
the first output Fourier transform component is configured to perform two 8-point Fourier transforms.

11. The configurable Fourier transform circuit of claim 1, wherein, to configure the configurable Fourier transform circuit as eight 32-point Fourier transforms:
the first input Fourier transform component is configured to perform four 4-point Fourier transforms; and
the first output Fourier transform component is configured to perform two 8-point Fourier transforms.

12. The configurable Fourier transform circuit of claim 1, further comprising a multiplexer configured to select one of a plurality of twiddle factors based on a mode of operation of the configurable Fourier transform circuit, wherein an output of the multiplexer is coupled to other inputs of the first set of multiplier circuits.

13. A method for configuring a Fourier transform circuit, comprising:
performing, via a first input Fourier transform component, Fourier transforms of one of multiple sizes by controlling a first set of multiplexers of the first input Fourier transform component;
performing, via a second Fourier transform component, Fourier transforms of one of the multiple sizes by controlling a second set of multiplexers of the first output Fourier transform component;
generating first input side Fourier transform signals via the configured first input Fourier transform component;
performing twiddle factor multiplications for the first input side Fourier transform signals via a first set of multiplier circuits to yield first multiplier output signals; and
generating first output side Fourier transform signals via the configured first output Fourier transform component based on the first multiplier output signals.

14. The method of claim 13, wherein at least one of the first input Fourier transform component or the first output Fourier transform component comprises computation circuitry that is shared when performing the Fourier transforms of the multiple sizes.

15. The method of claim 13, further comprising:
performing, via a second input Fourier transform component, Fourier transforms of one of multiple sizes by controlling a third set of multiplexers of the second input Fourier transform component;
performing, via a second output Fourier transform component, Fourier transforms of one of the multiple sizes by controlling a fourth set of multiplexers of the second output Fourier transform component;
generating second input side Fourier transform signals via the configured second input Fourier transform component;
performing twiddle factor multiplications for the second input side Fourier transform signals via a second set of multiplier circuits to yield second multiplier output signals; and
generating output side Fourier transform signals via the configured second output Fourier transform component based on the second multiplier output signals.

16. The method of claim 13, wherein the configurable Fourier transform circuit is configured to perform one 256-point Fourier transform, two 128-point Fourier transforms, four 64-point Fourier transforms, or eight 32-point Fourier transforms.

17. The method of claim 13, wherein at least one of the first input Fourier transform component or the first output Fourier transform configured to perform one 16-point Fourier transform, two 8-point Fourier transforms, or four 4-point Fourier transforms.

18. The method of claim 13, wherein generating the input Fourier transform signals comprises performing computations via a computation circuit coupled to outputs of the first set of multiplexers.

19. The method of claim 13, wherein generating the first output Fourier transform output signals comprises performing computations via a computation circuit coupled to outputs of the second set of multiplexers.

20. The method of claim 13, wherein configuring the configurable Fourier transform circuit as a 256-point Fourier transform comprises:
performing, via the first input Fourier transform component, a 16-point Fourier transform; and
performing, via the first output Fourier transform component, a 16-point Fourier transform.

21. The method of claim 13, wherein configuring the configurable Fourier transform circuit as two 128-point Fourier transforms comprises:
performing, via the first input Fourier transform component, two 8-point Fourier transforms; and
performing, via the first output Fourier transform component, a 16-point Fourier transform.

22. The method of claim 13, wherein configuring the configurable Fourier transform circuit as four 64-point Fourier transforms comprises:
performing, via the first input Fourier transform component, two 8-point Fourier transforms; and
performing, via the first output Fourier transform component, two 8-point Fourier transforms.

23. The method of claim 13, wherein configuring the configurable Fourier transform circuit as eight 32-point Fourier transforms comprises:
performing, via the first input Fourier transform component, four 4-point Fourier transforms; and
performing, via the first output Fourier transform component, two 8-point Fourier transforms.

24. The method of claim 13, further comprising selecting, via a multiplexer, one of a plurality of twiddle factors based on a mode of operation of the Fourier transform circuit, wherein the twiddle factor multiplications are performed based on the selection.

25. A non-transitory computer-readable medium storing information representing a configurable Fourier transform circuit, comprising:
a first input Fourier transform component having a first set of multiplexers, wherein the first input Fourier transform component is configurable to perform Fourier transforms of different transform sizes by controlling the first set of multiplexers;
a first set of multiplier circuits having inputs coupled to outputs of the first input Fourier transform component; and
a first output Fourier transform component having inputs coupled to outputs of the first set of multiplier circuits and having a second set of multiplexers, wherein the first output Fourier transform component is configurable to perform Fourier transforms of different transform sizes by controlling the second set of multiplexers.
